(19) United States
(12) Patent Application Publication
(10) Pub. No.: US 2026/0268410 A1
(43) Pub. Date: Sep. 10, 2026

(54) DIGITAL ASSET MANAGEMENT SYSTEM, METHOD AND MEDIUM

(71) Applicant: Rakuten Group, Inc., Tokyo (JP)

(72) Inventors: Hajime NISHINOMIYA, Tokyo (JP); Shunichiro SEKIGUCHI, Tokyo (JP); Sean CASEY, Tokyo (JP); Steven MORTON, Tokyo (JP); Ryusuke NAMBU, Tokyo (JP); Shoichiro NAGAI, Tokyo (JP); Risa NAKASHIMA, Tokyo (JP)

(73) Assignee: Rakuten Group, Inc., Tokyo (JP)

(21) Appl. No.: 18/837,789

(22) PCT Filed: Sep. 29, 2023
(86) PCT No.: PCT/JP2023/035605

§ 371 Date: May 29, 2026

(51) Int. Cl. G06Q 40/06; G06Q 40/04

(52) U.S. Cl. CPC G06Q 40/063; G06Q 40/055

(57) ABSTRACT

A digital asset management system 100 includes: a lock instructing unit 22 that instructs a supported service to perform lock processing of a digital asset to which a first user 9 has a right; an NFT issuing unit 23 that issues an NFT, of which holder is the first user, for the locked digital asset; an unlock instructing unit 25 that instructs the supported service to perform unlock processing for a digital asset, and instructs the supported service, at a timing of the unlock processing, to perform unlock after setting a user corresponding to the holder of the NFT as a user having a right to the digital asset; and an NFT invalidating unit 26 that, in a case of performing the unlock, causes the NFT to transit to an unusable state.

### FIELD

The present disclosure relates to a management technique of digital assets.

### BACKGROUND

Techniques for generating and trading non-fungible tokens using a blockchain have been proposed (see Non-Patent Literature 1 and 2).

An electronic ticket management system has been proposed, which includes: electronic ticket issuing means for issuing a non-fungible token type electronic ticket by providing a parameter that adds a utility value for a purpose other than participation in an event; issued information registering means for registering electronic ticket issuing information, which includes a token ID, a ticket ID, an owner ID, and a parameter, in a distributed ledger; electronic ticket transfer means for creating transfer information including owners IDs before and after a change of ownership of the electronic ticket when the ownership is transferred; and transfer information registering means for registering the transfer information in the distributed ledger (see Patent Literature 1).

### CITATION LIST

### Patent Literature

[PTL 1] Japanese Patent Application Publication No. 2022-002008

### Non-Patent Literature

[NPL 1] William Entriken and three others: EIP-721: Non-Fungible Token Standard, https://eips.ethereum.org/EIPS/eip-721

[NPL 2] Witek Radomski and five others: EIP-1155: Multi Token Standard, https://eips.ethereum.org/EIPS/eip-1155

### SUMMARY

In the management of digital assets not using non-fungible tokens, there have been problems in terms of convenience and safety. Various techniques to manage and trade digital assets by generating non-fungible tokens have been proposed, but the system of management, use and disposal of digital assets is based on the premise that non-fungible tokens have already been provided, hence if conventional digital assets, which are not based on management using non-fungible tokens, are to be managed with non-fungible tokens that are newly provided, then a new system has to be constructed to use or dispose the digital assets.

With the foregoing in view, it is an object of the present disclosure to improve convenience and safety in the management of digital assets to which a user has rights in a predetermined service.

An example of the present disclosure is a digital asset management system, including: a lock instruction unit for instructing a predetermined supported service to perform lock processing so as to limit use or disposal of a digital asset which is provided by the supported system and to which a first user has a right; a non-fungible token issuing unit for issuing a non-fungible token, of which holder is the first user, for the digital asset locked by the supported service, on a distributed ledge such that the non-fungible token is corresponded with metadata which indicates data related to the digital asset; an unlock instruction unit for instructing the supported service to perform unlock processing so as to cancel the limit of use or disposal of the digital asset locked by the supported service, and for instructing the supported service, at the timing of the unlock processing, to perform unlock after setting a user corresponding to a holder of the non-fungible token as a user having a right to the digital asset; and a non-fungible token invalidating unit for, in the case of the unlock processing, causing the non-fungible token related to the unlock processing to transit to an unusable state.

The present disclosure may be recognized as a method executed by an information processor, a system, or a computer, or a program executed by a computer. The present disclosure may also be recognized as such a program recorded in a recording medium that is readable by a computer or other devices, machines and the like. Here the recording medium that is readable by a computer or the like refers to a recording medium that stores such information as data and programs by electronic, magnetic, optical, mechanical or chemical function, and is readable by a computer or the like.

According to the present disclosure, in the management of a digital asset to which the user has a right in a predetermined service, convenience and safety can be improved.

### BRIEF DESCRIPTION OF THE DRAWINGS

FIG. 1 is a schematic diagram depicting a configuration of a system according to an embodiment,

FIG. 2 is a diagram depicting an overview of a functional configuration of the system according to an embodiment,

FIG. 3 is a flow chart depicting a flow of preparation processing according to an embodiment,

FIG. 4 is a flow chart (1) depicting a flow of account linking processing according to an embodiment,

FIG. 5 is a flow chart (2) depicting a flow of account linking processing according to an embodiment,

FIG. 6 is a diagram depicting an overview of check-in according to an embodiment,

FIG. 7 is a flow chart depicting a flow of check-in processing according to an embodiment,

FIG. 8 is a diagram depicting an overview of transaction of an NFT according to an embodiment,

FIG. 9 is a flow chart depicting a flow of exhibition processing according to an embodiment,

FIG. 10 is a flow chart depicting a flow of transfer of right processing according to an embodiment,

FIG. 11 is a diagram depicting an overview of check-out according to an embodiment,

FIG. 12 is a flow chart depicting a flow of check-out processing according to an embodiment, and

FIG. 13 is a diagram depicting an overview of use of a digital asset according to an embodiment.

### DESCRIPTION OF EMBODIMENTS

Embodiments of a system, an information processor, a method, and a program according to the present disclosure will be described with reference to the drawings. The embodiments to be described below are examples of the embodiments, and are not intended to limit the system, the information processor, the method, and the program according to the present disclosure to the specific configurations described below. To carry out the invention, specific configurations in accordance with each embodiment will be used appropriately, and may be modified or changed in various ways.

In the following embodiments, a case of applying a technique of the present disclosure to a digital asset management system will be described, and in this digital asset management system, NFT based on a digital asset provided by a predetermined supported service is issued so that the NFT can be checked, exhibited and purchased on the digital asset management system, and then can be returned to a state where the NFT can be used by the original supported service, as a digital asset of the latest holder. The present disclosure, however, can be widely used for improving convenience and safety in the transfer of right to the digital asset which the user has the right, and the application targets of the present disclosure are not limited to the examples to be described in the embodiments.

Conventionally there has been issues with the management and transfer of right to a digital asset without using a non-fungible token in terms of convenience and safety. Various techniques to manage and trade a digital asset by generating a non-fungible token have been proposed, but the system of management, use or disposal of a digital asset is based on the premise that a non-fungible token has already been provided, hence if a conventional digital asses, which is not based on management using a non-fungible token, is to be managed with a non-fungible token that is newly provided, a new system must be constructed to use or dispose the digital asset. With the foregoing in view, the system according to the present embodiment is to solve all or at least part of the above mentioned problems.

A non-fungible token (hereafter “NFT”) is a type of a cryptographic token that indicates the ownership of a subject, and cannot be replaced by another token, unlike a fungible token (hereafter “FT”) that can be replaced by another token if both have the same value, such as cryptocurrency. In the present embodiment, an example of issuing and trading NFTs by recording data indicating the correspondence between NFT and an object (e.g. data including a has value) on a blockchain will be described. However a technique that can be used to issue and trade NFTs is not limited to this.

### Configuration of System

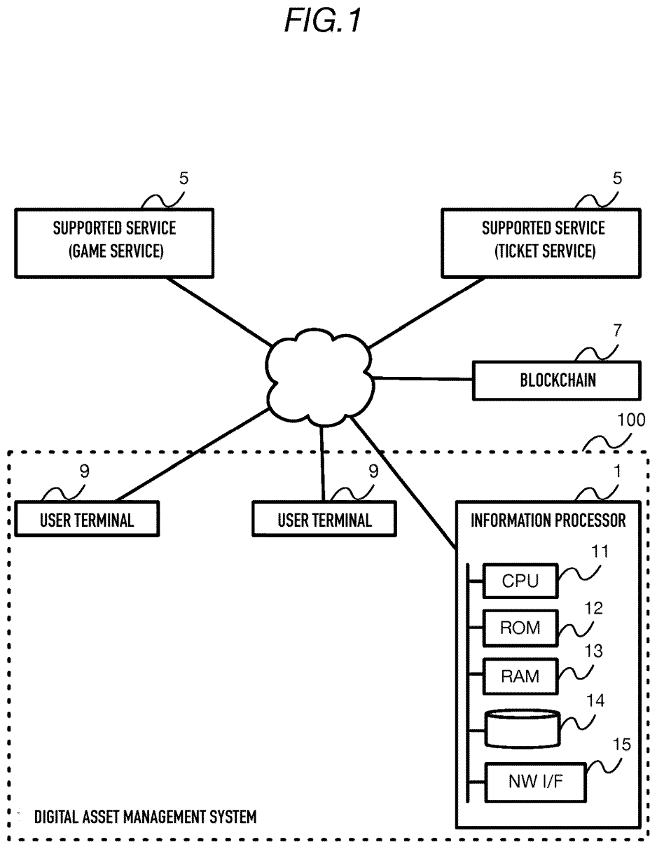

FIG. 1 is a schematic diagram depicting a configuration of a digital asset management system 100 according to the present embodiment. The system according to the present embodiment includes an information processor 1 and a plurality of terminals 9 which are communicably connected to a network. The digital asset management system 100 is also connected to one or a plurality of supported services 5, which provide digital assets to user, and a blockchain 7.

The information processor 1 is a computer which includes a central processing unit (CPU) 11, a read only memory (ROM) 12, a random access memory (RAM) 13, a storage device 14, such as an electrically erasable and programmable read only memory (EEPROM) and a hard disk drive (HDD), a communication unit 15, such as a network interface card (NIC), and the like. For a specific hardware configuration of the information processor 1 however, composing elements may be omitted, replaced or added in accordance with the mode of the embodiment. Further, the information processor 1 is not limited to a device constituted of a single casing. The information processor 1 may be implemented by a plurality of devices using such technologies as Cloud and distributed computing.

The user terminal 9 is a terminal device used by the user. The user terminal 9 is a computer including a CPU, a ROM, a RAM, a storage device, a communication unit, an input device, an output device, and the like (not illustrated). For a specific hardware configuration of the user terminal 9, however, composing elements may be omitted, replaced or added in accordance with the mode of the embodiment. Further, the user terminal 9 is not limited to a device constituted of a single casing. The user terminal 9 may be implemented by a plurality of devices using such technologies as Cloud and distributed computing. The user is connected to the information processor 1 via these user terminals 9, so as to manage NFTs and FTs, participate in a marketplace, and trade NFTs, for example.

The supported service 5 may be any service that provides some digital asset to the user, and may be called a digital asset provider, a digital asset platform, or the like. A type of service provided by the supported service 5 and a type of digital asset to be provided are not limited. For example, the supported service 5 may be: a game service that provides a game item or game data to the user as a digital asset; a ticket service that provides an electronic ticket or a physical ticket reservation right to the user as a digital asset; or an electronic book service that provides a right to reading an electronic book to the user as a digital asset. The supported service 5 may be a service to provide a right of access to some service to the user as a digital asset.

In the present disclosure, digital data to provide some right to the user, whether the data is recorded in the distributed ledger or not, is called a “digital asset”. In the present disclosure, “digital asset” is not limited to a digital asset of which right can be confirmed by the distributed ledger technique, such as a method of issuing NFTs. The target digital asset may be replaceable, such as game items of which number alone is managed, or may be irreplaceable, such as a reserved seat ticket and ticket with an admission number.

In the present embodiment, data as a substance of the digital asset (hereafter “digital asset data”) is managed by the supported service 5. In other words, the supported service 5 includes a data management system, and the data management system manages data of a digital asset, of which right is provided to a user, by linking this data at least with the user having the right. The type of data management system that can be used in the present embodiment is not limited, and may be a data management system that is closed within the supported service 5, or a location-orientated data management system, such as a content delivery network (CDN), or a content-oriented data management system, such as an interplanetary file system (IPFS).

When an NFT is issued, the digital asset management system 100 may manage data used for reference to trade the NFT, separately from master data which is managed by the supported service 5. The management method used for the data managed by the digital asset management system 100 as well is not limited, and may be a closed data management system, a location-oriented data management system, or a content-oriented data management system.

The blockchain 7 is used to issue and trade NFTs and FTs by registering data. In the present embodiment, a private blockchain is used as the blockchain, where only users having an account managed by a predetermined management entity (e.g. user ID issued by an administrator of the digital asset management system 100) can participate. Therefore in the present embodiment, a wallet of each user, including a purchaser of an NFT, is managed by being linked to an account. Here a wallet address corresponding to the wallet of each user is generated as required. The type of blockchain that can be used to carry out the technique according to the present disclosure, however, is not limited, and a consortium blockchain, where only users having accounts corresponding to a plurality of specific management entities respectively can participate, may be used, or a public blockchain may be used. To issue or trade NFTs, and to issue or trade FTs, a same blockchain may be used, or different blockchains may be additionally used.

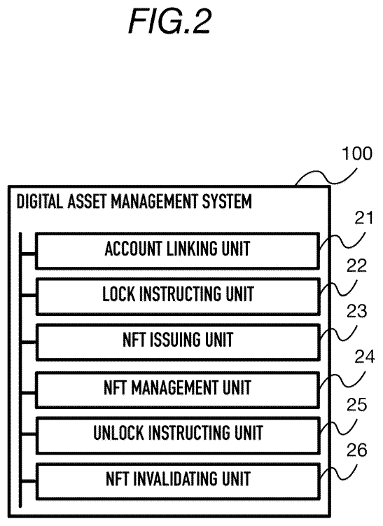

FIG. 2 is a diagram depicting an overview of a functional configuration of the digital asset management system 100 according to the present embodiment. The digital asset management system 100, including the information processor 1 and the user terminal 9, functions as a digital asset management system 100 constituted of: an account linking unit 21, a lock instructing unit 22, an NFT issuing unit 23, an NFT management unit 24, an unlock instructing unit 25, and an NFT invalidating unit 26, by programs recorded in the storage device that being to RAM, and being executed by the CPU, so as to control each hardware installed in the information processor 1 and the user terminal 9. In the present embodiment and in later mentioned embodiments, each function of the digital asset management system 100 is executed by the CPU (general purpose processor), but a part or all of these functions may be executed by one or a plurality of dedicated processors.

The account linking unit 21 holds the correspondence between an account (user ID) to identify a user in the supported service 5 and an account (user ID) to identify a holder of an NFT in the digital asset management system 100. The location to hold the data indicating the correspondence is not limited, and the data may be held in any of the supported service 5, a server of the digital asset management system 100, a user terminal 9, and an external database.

The lock instructing unit 22 instructs a predetermined supported service 5 to perform lock processing to limit use or disposal of a digital asset, which is provided by the predetermined supported service 5 and which a first user as a right. The instruction of the lock processing may be sent directly from the user terminal 9 to the supported service 5, or may be sent from the digital asset management system 100, which received a check-in request from the user terminal 9, to the supported service 5. In the present embodiment, conversion from the supported service 5 of the digital asset management to the digital asset management system 100, by issuing the NFT based on the digital asset, is called a “check-in”. The instruction of the lock processing for the digital asset may be sent directly from the user terminal 9 to the supported service 5, or may be sent from the user terminal 9 to the supported service 5 along with the check-in request. Here after receiving the instruction of the lock processing, the supported service 5 requests the digital management system 100 to generate the NFT. At this time, the digital management system 100 does not send the instruction to perform the lock processing to the supported service 5, but send an NFT issuing notification to the supported service 5 or to the user terminal 9.

The NFT issuing unit 23 records token data, including a metadata identifier, on the blockchain 7 for the digital asset locked by the supported service 5, whereby an NFT, of which holder is the first user and in which metadata indicating the data related to the digital asset and the digital asset are linked (are corresponded), is issued (is provided to the wallet of the holder). In the present embodiment, the digital asset is indirectly linked to the NFT via metadata like this. However the token data may include a hash value of the digital asset and CID, so that the digital asset is directly linked to the NFT. Further, in the present embodiment, a plurality of NFTs linked to one digital asset may be issued. In this case, the NFT issuing unit 23 issues a plurality of NFTs linked to the one digital asset using: a method of generating a plurality of metadata, including a combination of a common content identifier (CID) and mutually different additional data (e.g. serial number), and recording the plurality of token data corresponding to the generated plurality of metadata respectively in the blockchain 7; or a method for recording the plurality of token data, including a combination of a common metadata identifier and mutually different additional data (e.g. serial number) on the blockchain 7, for example. The digital asset management system 100 may generate a new wallet at a provided destination (wallet address) when the NFT is issued (at the timing of issuing the NFT). The new wallet may be generated after the correspondence of the user ID in the supported service 5 and the user ID in the digital asset management system 100 is held (account linking) described above.

Here it is assumed that the meaning of “issue” of the NFT includes mint, issue, create and generate. In the present embodiment, an example of an NFT minted by the NFT issuing unit 23 directly enters the wallet of the user is mainly described, but to issue the NFT, the NFT issuing unit 23 may mint an NFT in the wallet of the system administrator first, then transfer the NFT to the wallet of the user, for example.

In the present embodiment, in addition to the data related to the digital asset acquired from the supported service 5, the NFT issuing unit 23 may supplement information, which is not included in the master data of the supported service 5, as metadata of the NFT when the NFT is issued, and write the data generated like this on the blockchain. Specifically, the NFT issuing unit 23 may record metadata, including attribute data generated by the digital asset management system 100, in an external server other than in the distributed ledger (an external server outside the blockchain 7 in the present embodiment), or may record the metadata in the distributed ledger, for example. Metadata, including data acquired from a service other than the supported service 5, may be recorded in an external server outside the blockchain 7, or may be recorded in the blockchain 7. Here “blockchain” refers to a blockchain network constituted of at least one node (e.g. server device).

The method for generating attribute data by the digital asset management system 100 is not limited, and, for example, the NFT issuing unit 23 may input data of a digital asset to a learned model (which learned using teacher data of which input value is data related to the digital asset, and output value is attribute data of this digital asset), causing the learned model to output estimated attribute data, so as to generate data to be included in the metadata. The teacher data can be created by, for example, merging data of the user, in which the supported service and the digital asset management system are linked, in an account (after acquiring approval from the user if necessary).

The method for the digital asset management system 100 to acquire data from a service other than the supported service 5 is not limited either, and, for example, the NFT issuing unit 23 may acquire data associated with the target user in another service (e.g. electronic commerce service, social networking service) linked to the digital asset management system 100 (after acquiring approval from the user if necessary).

The NFT management unit 24 manages an NFT which the NFT issuing unit 23 issued and provided to the wallet of the user. In the present embodiment, the digital asset may include a predetermined right related to the digital asset linked to the NFT and other benefits (e.g. points, data).

In the present embodiment, the NFT management unit 24 registers an NFT issued by the NFT issuing unit 23 in a marketplace according to the operation of the holder of this NFT, whereby this NFT can be purchased from another user, including a second user. The NFT management unit 24 also receives the purchase operation from the second user for the NFT registered in the marketplace. Once the purchase is approved, the NFT management unit 24 changes the holder of the NFT from the first user (exhibitor) to the second user (purchaser).

The NFT management unit 24 also refers to the wallet of the user, responding to a request (e.g. API call) from the supported service or the digital asset management system 100 itself, and acquires a list of NFTs that this user currently holds.

The unlock instructing unit 25 instructs a supported service 5 to execute unlock processing to cancel the limit of use or disposal of a digital asset locked by this supported service 5. Here the unlock instructing unit 25 instructs the supported service 5, at the timing of the unlock processing, to perform unlock after setting a user corresponding to a holder of the NFT related to the unlock target digital asset as a user having a right to this digital asset. In other words, in a case where the holder of the NFT has been changed to the second user at the timing of the unlock, the unlock instructing unit 25 instructs the supported service 5 to perform unlock after setting the second user, who became the holder of the NFT by the holder change, as the user having the right to the digital asset. On the other hand, in a case where the holder of the NFT remains the first user at the timing of the unlock, the unlock instructing unit 25 instructs the supported service 5 to perform unlock after setting the first user, who is the holder of the NFT at the timing of lock, as the user having the right to the digital asset. Here the unlock instructing unit 25 can refer to the correspondence created by the account linking unit 21 to specify a user ID of the NFT holder in the supported service 5.

Just like the case of lock processing, the instruction of the unlock may be sent directly from the user terminal 9 to the supported service 5, or may be sent from the digital asset management system 100, which received a check-out request from the user terminal 9, to the supported service 5. In the present embodiment, reconversion of the digital asset management from the digital asset management system 100 to the supported service 5, by causing the NFT issued to the digital asset to transit to an unusable state, is called a “check-out”. The instruction of the unlock processing for the digital asset may be sent directly from the user terminal 9 to the supported service 5, or may be sent from the user terminal 9 to the supported service 5 along with the check-out request. Here after receiving the instruction of the unlock processing, the supported service 5 requests the digital management system 100 to delete the NFT (invalidation request, burning request). At this time, the digital management system 100 does not send the instruction of the unlock processing to the supported service 5, and sends an NFT burning notification to the supported service 5 or to the user terminal 9.

In the case of the unlock processing, the NFT invalidating unit 26 causes the NFT related to this unlock processing to transit to an unusable state. The method for causing the NFT to transit to an unusable state is not limited, and, for example, in the case of the unlock processing, the NFT invalidating unit 26 may burn the NFT related to this unlock processing to cause this NFT to transit to an unusable state. The method for causing the NFT to transit to an unusable state may be, for example, a method for moving the NFT to a predetermined invalid wallet address, or a method of providing a predetermined flag. By causing the NFT to transit to an unusable state, such a situation as the redundant transfer of a digital asset can be prevented.

### Flow of Processing

A flow of processing that is executed in the system according to the present embodiment will be described next. Specific content and processing sequence of the processing to be described below are an example for carrying out the present disclosure. The specific processing content and processing sequence may be selected as required in accordance with the embodiment of the present disclosure.

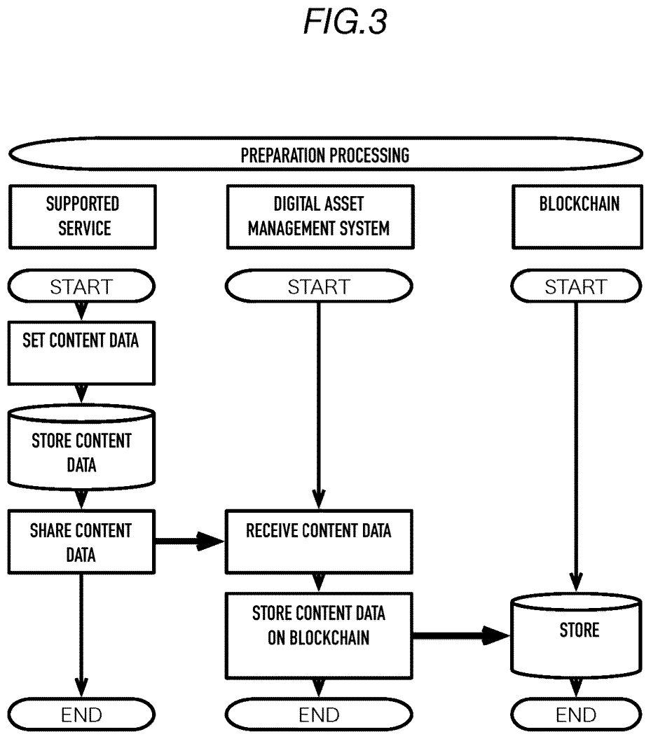

FIG. 3 is a flow chart depicting a flow of preparation processing according to the present embodiment. The processing in this flow chart is executed as preparation processing for a digital asset provided by the supported service 5, so that asset management can be converted to the digital asset management system 100.

In the supported service 5, content data, which is a base of the digital asset, has been set and saved in a server of the supported service 5 in advance. The digital asset is generated when a right to the content data, which is set here, is set for the user. The supported service 5 shares the content data with the digital asset management system 100, and the digital asset management system 100 stores the data related to the shared content data on the blockchain 7 as metadata for each content data (content itself or attribute (parameter) of content). The “data related to content data” here is, for example, a specification of an item, a name, an image, and the like in the case of a game item; an event content (e.g. artist name, event name) and a site and a date of the event in the case of a ticket; and contents of an electronic book in the case of an electronic book. The digital asset management system 100 may store a part of the data related to the content data as metadata, and store the other data as token data.

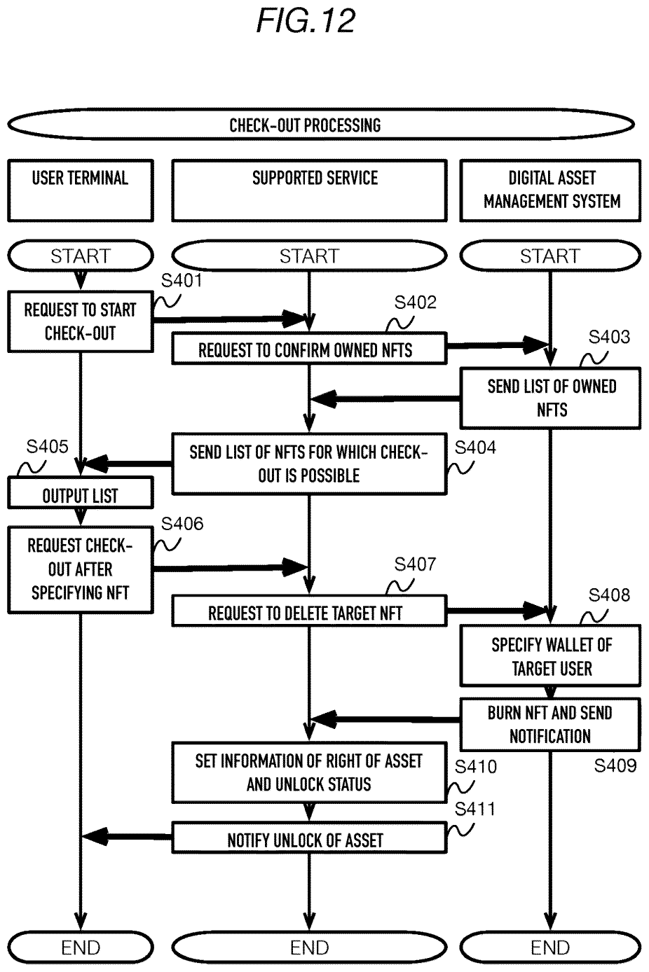

Then when an NFT is issued for a digital asset based on the content data in the later mentioned check-in processing, the content data is linked to this NFT using a identifier (e.g. serial number, token ID) which is provided to each content data and is stored on the blockchain 7. Thereby in the processing to delete the NFT and to unlock the status of the digital asset and set a right owner (see steps S407 to S410 in FIG. 12) in the check-out processing, various information of the content data written in the metadata corresponding to the NFT on the blockchain 7 are referred to, and are used for specifying a digital asset for which the right holder is set.

The content of the data recorded on the blockchain 7 for each content data are not limited, and the following are examples.

### (1) Common Metadata of a Game Item

CollectibleID (item ID mapped on the supported service 5 side)
AssetProviderID (ID of the supported service 5. ID of the game service provider in this case).
Name (name, item name in this case)

### (2) Common Metadata of a Ticket

CollectibleID (event ID mapped on the supported service 5 side)
AssetProviderID (ID of the supported service 5. ID of the ticket service provider in this case)
Name (name, event name+seat type+seat name in this case)

Further, in the present embodiment, the following items, for example, may be used for the items included in the metadata.
externalURL (URL to guide the user to the page of the service or content)
rarity (rarity of the content or NFT)
series (series information of the content)

In the description of the present embodiment, the data common to the content has been recorded on the blockchain 7 in advance, but the data common to the content may also be recorded on the blockchain 7 when the NFT related to the digital asset is issued, as described later.

The metadata may further include information on the supported service 5, information on performer related to the content, credit information on intellectual property rights (e.g. copyright, trademark right, right of performer) related to the content, information on group related to the content, date and time information related to the content, location information (e.g. event site, and the like, metaverse and streaming event may be included) related to the content, and event information (e.g. series/season name of a sports game, event name, concept) related to the content, and the like. Here “performer” includes an actor and a musical performer, a player in sports content, and members in an idol/band content. “Group” includes a team name in a sports content, a group name in an idol content, and a group name in a band content. “Date and time” includes release date and time, and recording date and time of the content. This information may be included in the metadata and/or the digital asset data as independent items, or may be included in a comprehensive item, such as “description” and “series” mentioned above. The information on performer may include a role of this performer in the content (position (e.g. pitcher) in the sports content, position in the idol contents, musical instrument in the band contents, and the like).

In the above mentioned example, master data/digital asset ID of the digital asset owned by the supported service 5 is written as the metadata, but even for the digital asset of the supported service 5, which does not include the master data or which is insufficient as the metadata, the digital asset management system 100 may supplement various profiles/attributes for the metadata on the blockchain 7, so as to be manageable by the digital asset management system 100.

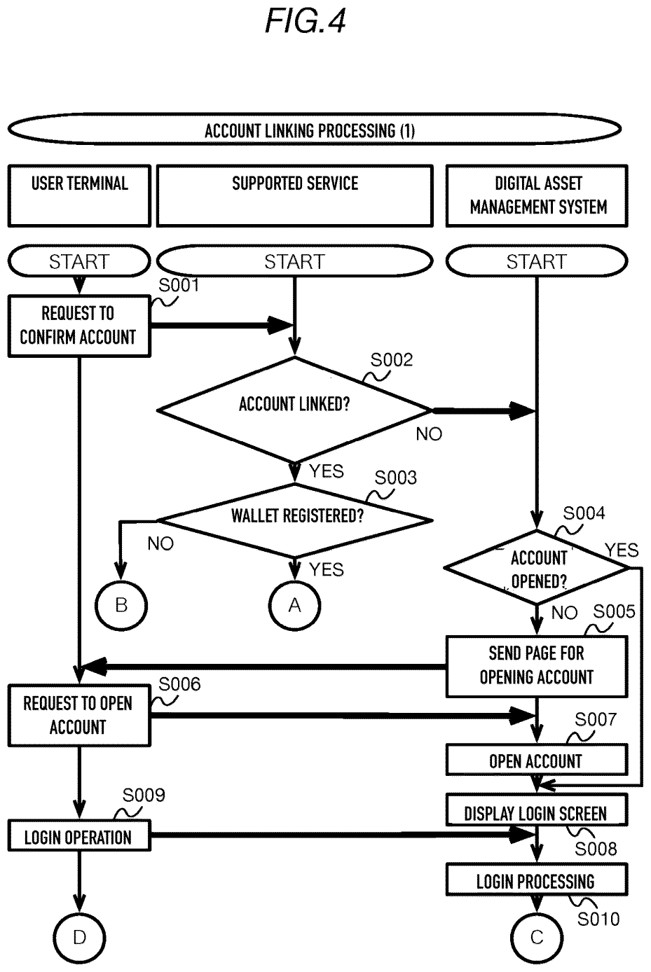

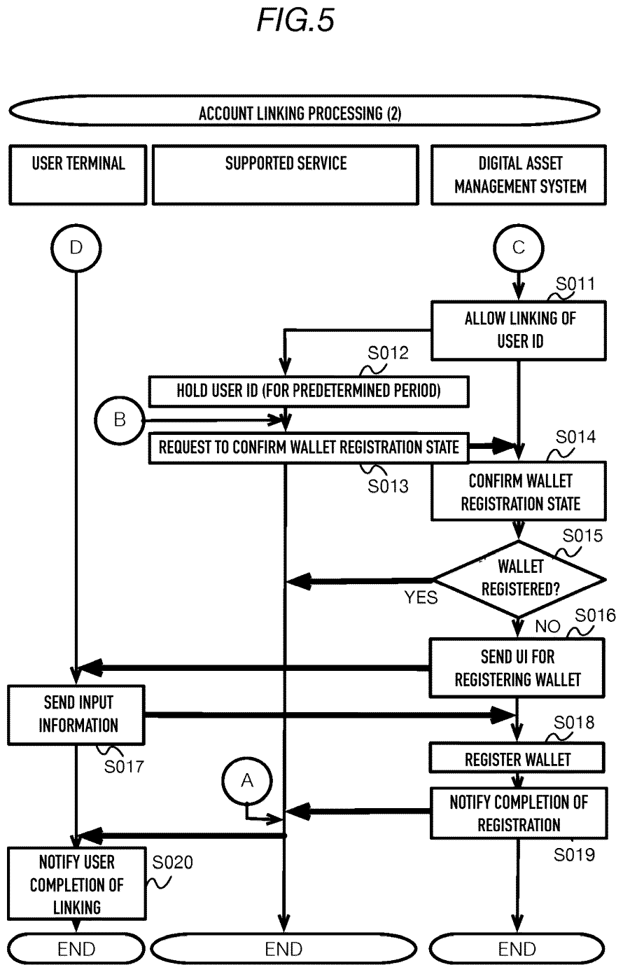

FIGS. 4 and 5 are flow charts depicting a flow of the account linking processing according to the present embodiment. The processing in the flow charts is executed at a timing when the user terminal 9, which received instruction for account linking or for operation of check-in/check-out from the user, sends an account confirmation request to the server of the supported service 5.

The supported service 5, which received the account confirmation request (step S001), confirms, for the user who performed this operation, whether the account of the digital asset management system 100 of this user is linked to the account of the supported service 5 of this user, and whether this user has already registered an NFT wallet (hereafter called “wallet”) in the digital asset management system 100 (steps S002 and S003). This confirmation may be performed by referring to the account information recorded in the data of the account logged in the supported service 5. If the account has been linked and the registration of the wallet has been confirmed, the user terminal 9, which received the notification from the supported service 5, notifies the user that the account linking processing is completed (step S020). When the account linking processing completes, the processing in this flow chart ends. As mentioned above, the wallet registration is not always required in the account linking processing.

If the account has not been linked (unlinked state), the supported service 5 connects the user terminal to the digital asset management system 100. The account linking unit 21 of the digital asset management system 100, to which the user terminal is connected, determines whether this user has already opened an account in this digital asset management system 100 (step S004). This determination may be performed by asking the user whether the registration has been completed, or by prompting the user to attempt a login. If the user has not opened the account in this digital asset management system 100 as a result of the determination, the account linking unit 21 causes the user terminal 9 to display an account opening page (step S005), and causes the user to open a new account steps S006 and S007). For the account opening processing, a conventional or future account management technique may be used, and detailed description thereof is omitted here.

In the case where this user has already opened an account in the digital asset management system 100, or in the case where a new account of the user has been opened, the account linking unit 21 causes the user to perform the login operation to this new account (steps S008 to S010). For the login processing, a conventional or future account management technique may be used, and detailed description thereof is omitted here. When the login completes, the account linking unit 21 approves the server of the supported service 5 to link the user ID related to this account (step S011), and the supported service 5 holds the user ID for a predetermined period (Step S012), whereby NFT-related operations (e.g. API call) for the supported service 5 can be performed for the user having this user ID. Then processing advances to the registration state confirmation of an NFT wallet.

In the case where the account has already been linked (or a new account is linked), but registration of the NFT wallet has not yet been confirmed (unconfirmed state), the supported service 5 confirms the digital asset management system 100 about the registration state of the NFT wallet with specifying the user ID (step S013, specifically, an API for confirming the registration state of the NFT wallet provided by the digital asset management system 100 is called). The account linking unit 21 of the digital asset management system 100 that received the inquiry about the registration state of the NFT wallet confirms whether the registered NFT wallet exists for the specified user ID (step S014). If the NFT wallet has been registered for the specified user ID (YES in step S015), the user terminal 9 which received the notification from the supported service 5 notifies the user that the account linking processing is completed (step S020), and the processing in this flow chart ends.

If the NFT wallet has not been registered (unregistered state) with the specified user ID (NO in Step S015), on the other hand, the account linking unit 21 of the digital asset management system 100 displays a registration interface to create and register the NFT wallet for the user terminal 9 (step S016), and receives information, inputted by the user in accordance with this registration interface, from the user terminal 9 (step S017), and thereby registers the NFT wallet for this user (step S018). Here the registration processing of the NFT wallet is generally the same as the conventional wallet registration, and detailed description thereof is omitted here. When the registration of the NFT wallet completes, the account linking unit 21 notifies the supported service 5 that registration of the wallet is completed (step S019), and the user terminal 9, which received the notification from the supported service 5, notifies the user that the account linking processing is completed (step S020), and the processing of this flow chart ends. Instead of registering the wallet, issuing and registering (member registration) of the user ID in the digital asset management system 100 may be confirmed, or a registration interface may be displayed.

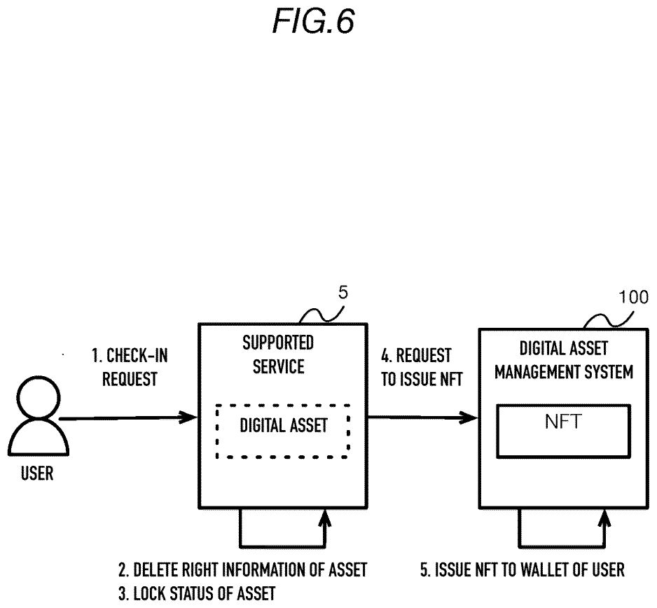

FIG. 6 is a diagram depicting an overview of check-in according to the present embodiment. When the user requests check-in to the supported service 5, the supported service 5 deletes the right information of the digital asset, and locks the status of the digital asset. Then the supported service 5 requests the digital asset management system 100 to issue an NFT related to a target digital asset, and the digital asset management system 100, which received the request, issues the NFT related to the target digital asset. The flow of the check-in processing according to the present embodiment will now be described with reference to a flow chart.

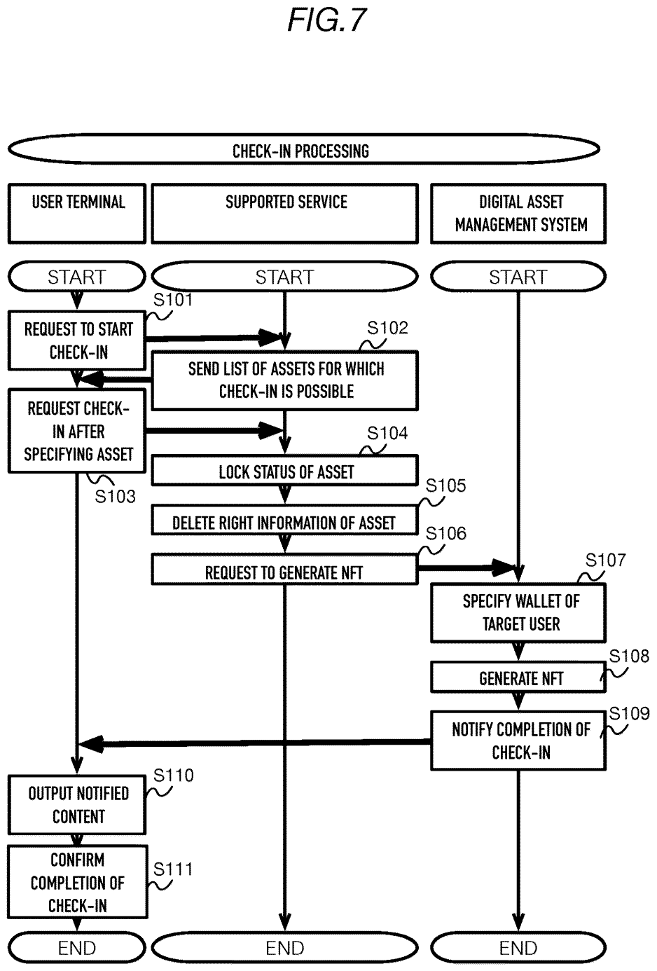

FIG. 7 is a flow chart depicting a flow of the check-in processing according to the present embodiment. The processing in this flow chart is executed at a timing when the operation to start the check-in processing is performed in the user terminal 9 of the user, who desires to shift the management of the digital asset provided by the supported service 5 to the digital asset management system 100.

In steps S101 to S103, a list of the digital assets for which check-in is possible is presented, and the check-in is requested. The user terminal 9, which receives the operation to start the check-in processing from the user, sends a request to start the check-in processing to the server of the supported service 5 (step S101). When the supported service 5 receives the request to start the check-in operation sent from the user terminal 9, the supported server 5 generates a list of digital assets, of which management can be shifted to the digital asset management system 100 (that is, digital assets of which check-in is possible), out of the digital assets which are provided by the supported service 5, and which the user has the right (holds), and sends the list to the user terminal 9 (step S102). If the digital assets are items of a game here, for example, an item that is set to “in use” in the game is removed from the list.

The user terminal 9, which received the list of the digital assets for which check-in is possible, outputs the list such that the user can confirm (e.g. displays on a display), and receives operation by the user to select a desired check-in target digital asset. When the operation to select the check-in target digital asset is received, the user terminal 9 specifies the check-in target digital asset, and sends the check-in request to the server of the supported server 5 (step S103). Then processing advances to step S104.

In steps S104 to S106, status lock and delete of the right information are performed for the digital asset related to the check-in request. When the check-in request sent from the user terminal 9 is received, the supported service 5 locks the status of the digital asset related to the check-in request (check-in target digital asset), out of the digital assets which are provided by the supported service 5, and which the user has the right (holds) (step S104), and deletes the right information of the user attached to the check-in target digital asset (step S105). The specific method for deleting the right information is not limited, and, for example, linking of the item to the user data may be deleted, or the item may be deleted from the user library. Thereby the use or disposal of the check-in target digital asset can be limited. Then processing advances to step S106.

In steps S106 to S108, an NFT of the check-in target digital asset is issued. The supported server 5 sends a request to the server of the digital asset management system 100 to link the user ID, a request to link the parameter of the check-in target digital asset, and a request to generate an NFT related to the linked user ID and parameter (step S106). Specifically, the supported service 5 calls an API for linking the user ID, an API for linking a parameter of the check-in target digital asset, and an API for generating an NFT related to the linked user ID and parameter, which are provided by the digital asset management system 100. The NFT issuing unit 23 of the digital asset management system 100, which received the request to generate the NFT, specifies a wallet held by this user with referencing the linked user ID (step S107), and issues the NFT of the linked check-in target digital asset to the specified wallet of the user (step S108). Then processing advances to step S109. If the NFT issuing unit 23 cannot specify a wallet held by the user here, the digital asset management system 100 may issue a new wallet (wallet address) for the user.

More specifically, based on a key including a parameter of the check-in target digital asset, the NFT issuing unit 23 calculates a hash value using a predetermined hash algorithm. Then the NFT issuing unit 23 creates an electronic signature using the calculated hash value and the private key of the supported service 5. For the processing of the electronic signature, a conventional or a future electronic signature technique may be used, and detailed description thereof is omitted here. A public key corresponding to the private key used here is disclosed in a marketplace. Thereby anyone who can acquire a public key can confirm the validity of the digital asset. When the electronic signature is created, the NFT issuing unit 23 generates metadata of the digital asset, including the hash value, the electronic signature, and a resource identifier which is referred to when the digital asset data is acquired. Here the URI of the metadata may include the CID, which was generated in advance in accordance with the protocol of the IPFS. Thereby even if the digital asset data is added to the IPFS, the digital asset data can be acquired from the IPFS by specifying this URI. Then the token data is recorded on the blockchain 7, whereby the NFT is issued. The NFT issuing unit 23 creates the token data including the metadata CID, and records the created token data directly on the blockchain 7, whereby the NFT linking the metadata and the digital asset is issued and provided to the wallet of the holder.

In steps S109 to S111, completion of the check-in is notified. When the NFT of the check-in target digital asset is issued, the digital asset management system 100 notifies the user terminal 9 that the check-in is completed (step S109). Then the user terminal 9, which received the notification outputs the notification content for confirmation (e.g. displays on the display) (step S110), and causes the user to confirm the issued NFT (step S111). Then the processing in this flow chart ends.

For the token data of the NFT, the following token data can be used, for example. The follow example is based on the assumption that a collectible type token, in which a plurality of NFTs are issued for one digital asset (that is, a same type of game items are managed by the number of items), is used. The token to be used may be changed as required in accordance with the type of the digital asset.
tokenID (token ID)
tokenMetadataURI (URI to refer to metadata from NFT when the NFT is issued, and includes the CID of the metadata).

Metadata may further include the attributes of the digital asset data, in addition to the location information (including URI and CID) to refer to the digital asset data, which is generally used for NFTs, the hash value of the digital asset data, and the electronic signature of the digital asset data.

In the digital asset management system 100, various data may supplement the metadata on the blockchain 7, just like the case of registering the content data on the blockchain in the preparation processing mentioned above.

Here when the NFT is issued, the NFT issuing unit 23 supplements the information, which the supported service 5 does not own as master data, as metadata corresponding to the NFT, in addition to the data related to the digital asset acquired from the supported service 5. The method for storing the data is as described above in the description of the NFT issuing unit 23.

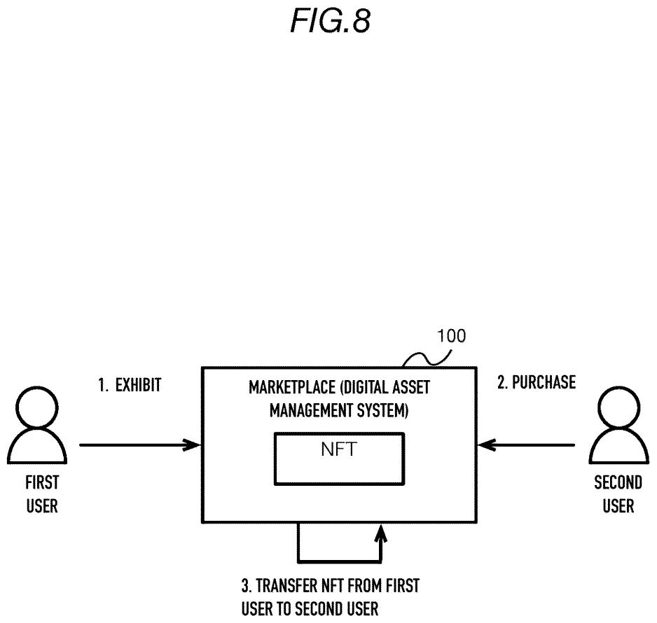

FIG. 8 is a diagram depicting an overview of transaction of an NFT according to the present embodiment. When a first user exhibits an NFT in a marketplace, and a second user purchases this NFT, the holder of the NFT is transferred from the first user to the second user. The flow of the exhibition processing and the transfer of right processing related to the transaction of the NFT according to the present embodiment will be described with reference to the flow chart.

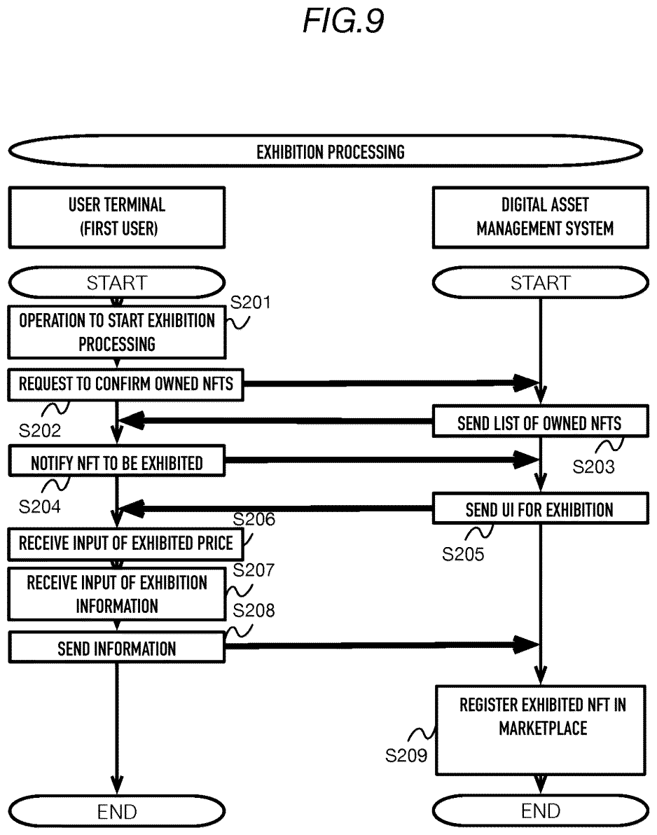

FIG. 9 is a flow chart depicting a flow of the exhibition processing according to the present embodiment. The processing indicated in this flow chart is executed at a timing when an operation to start the exhibition processing is performed at the user terminal 9 of the user who desires transfer of a right to the digital asset of which management has transferred to the digital asset management system 100.

In steps S201 to S205, when the operation to start the exhibition processing is received from the user, a user interface, to receive input of information for the exhibition, is outputted. The user terminal 9, which received the operation to start the exhibition processing from the user (step S201), requests the server of the digital asset management system 100 to display a page to confirm the NFTs held by this user (hereafter called “my collection page”) (step S202). The NFT management unit 24 of the digital asset management system 100 which received this request sends the my collection page of the target user to the user terminal 9 (step S203). The user terminal 9 which received the my collection page outputs this page (e.g. displays on the display) such that the user can confirm this information, receives selection of a desired NFT from the user, and notifies the selected NFT to the digital asset management system 100 (S204). The NFT management unit 24 of the digital asset management system 100 which received this notification causes the user terminal 9 to display a user interface (dialog) to receive input of information for exhibition (step S205). Then processing advances to step S206.

In steps S206 to S209, the NFT is exhibited in the marketplace. According to the interface for receiving the input of information for exhibition, the user terminal 9 receives input of information for exhibition, including input of an exhibition price of the NFT (step S206) and input of consent to the terms of the NFT transaction in the digital asset management system 100 (step S207), and sends this information to the digital asset management system 100 (step S208), whereby the exhibition processing is completed. The digital asset management system 100 which received the information for exhibition registers the target NFT in the marketplace, and hereafter the exhibited NFT is displayed in the marketplace of the digital asset management system 100 (step S209). Then the processing in this flow chart ends.

Here the method for determining the exhibition price of the NFT is not limited. For example, a method for making the NFT purchasable when a buyer agrees to the price that the seller presented in advance, may be used, or a method for determining a price agreeable between the seller and the buyer while changing the price, such as at an auction, may be used within an appropriate range.

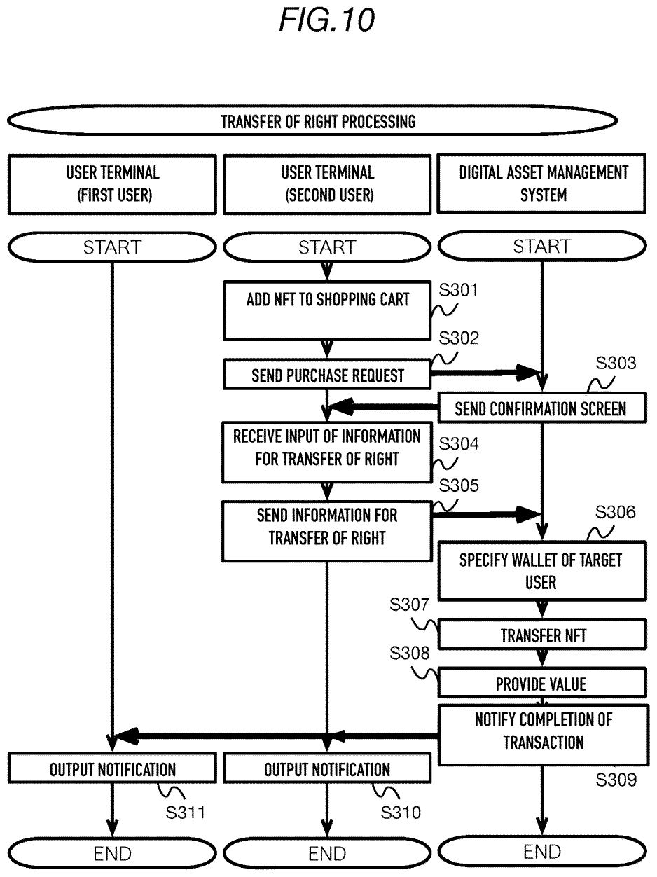

FIG. 10 is a flow chart depicting a flow of the transfer of right processing according to the present embodiment. The processing indicated in this flow chart is executed at a timing when operation to start the transfer of right processing is performed at a user terminal 9b of a second user who desires to acquire the right to the digital asset exhibited in the digital asset management system 100.

As mentioned above, the exhibited NFT is displayed in the marketplace of the digital asset management system 100. The user terminal 9b of the second user who desires to acquire the right to the digital asset exhibited in the digital asset management system 100 requests the server of the digital asset management system 100 to display a page to confirm the NFT exhibited in the marketplace of the digital asset management system 100, and the NFT management unit 24 of the digital asset management system 100 which received the request sends the data on the marketplace, including a list of currently purchasable NFTs and user interface for purchasing, to the user terminal 9b.

In steps S301 to S305, an NFT that the user desires to purchase is selected, and the inputted information for transfer of right is sent to the user terminal 9b. The user terminal 9b which received the data on the marketplace outputs a list of NFTs exhibited in the marketplace such that the user can confirm it (e.g. displays on the display), receives selection of a desired NFT in accordance with the user operation, and adds the selected NFT to a shopping cart (shopping cart used in electronic commerce) (step S301). Then when the user operation to proceed from the shopping cart to the purchase screen is received, the user terminal 9b sends the purchase request to the digital asset management system 100 (step S302). The NFT management unit 24 of the digital asset management system 100 which received the purchase request sends purchase confirmation screen data, including the user interface to receive input of information for the transfer of right, to the user terminal 9b (step S303). The user terminal 9b which received the purchase confirmation screen data outputs the purchase confirmation screen such that the user can confirm it (e.g. displays on the display), receives information input for transfer of right from the second user, including input of settlement method, and input of an order/settlement completion instruction (step S304), and sends this information to the digital asset management system 100 (step S305). In other words, when the seller exhibits an NFT in the marketplace, and the seller (here, the user who purchased the NFT from the supported service 5 and another user) and the buyer agree on the price of the NFT, the buyer sends a request to buy the NFT to the information processor 1, and proceeds to payment procedure. Then processing advances to step S306.

In steps S306 to S308, the NFT is transferred and payment value is provided. The NFT management unit 24 of the digital asset management system 100 which received the information for the transfer of right specifies a wallets of the first user and the second user, referring to the user ID of the first user and the user ID of the second user (step S306), and transfers the target NFT from the wallet of the first user to the wallet of the second user (step S307). The NFT management unit 24 of the digital asset management system 100 also provides a value, which is paid from the second user to the first user at the transfer of right, to the first user (step S308), then processing advances to step S309.

Here the transfer of the NFT is preferably executed simultaneously with and inseparably from the transfer of the value to be received by the seller and/or the right holder (provision of FT to the seller and/or the right holder if the value is FT). For example, the NFT management unit 24 may process the transaction to transfer NFT and/or FT based on the transaction form of the unspent transaction output (UTXO), or may process the transaction to transfer NFT and/or FT based on the form of the smart contract. Such a transaction on the blockchain 7 is effective to increase security of the transaction, especially in a C2C transaction (including secondary transaction between users of a sold NFT and transaction by general users selling an NFT for the supported service 5). The timing of transfer of the NFT is not limited to the examples mentioned here.

In the present embodiment, the type of value that is used for payment of the transaction is not limited. The value used for payment of the transaction may be cryptocurrency, legal currency, or such electronic value as points and electronic money issued by a manager. In the present embodiment, settlement means for paying with legal currency is assumed to be a credit card, a debit card, electronic money, and the like, and settlement means for paying with points is assumed to be a point management system of the point manager. The settlement means is not limited to the examples in this embodiment either, and various conventional or future settlement means may be used whether it is a pre-payment system or a post-payment system. For example, in the case of using cryptocurrency for payment, a blockchain network is used as the settlement means for the target cryptocurrency. If the value used for the payment of the transaction is cryptocurrency, the provision of the value may be recorded on the blockchain along with the transfer of the NFT.

In steps S309 to S311, completion of the transaction is notified. When the transfer of the NFT and provision of the value (if any) are completed, the NFT management unit 24 of the digital asset management system 100 notifies the completion of the transaction to the user terminal 9a of the first user and to the user terminal 9b of the second user (step S309). The user terminal 9a of the first user and the user terminal 9b of the second user, which received the notification, output the completion of the transaction respectively such that the first user and the second user can confirm this information (steps S310 and S311). Then the processing in this flow chart ends.

A number of NFTs that the buyer can purchase is not limited to one, and the buyer may purchase a plurality of NFTs in bulk. Further, the plurality of NFTs may be a pack containing a plurality of NFTs created by the seller. Furthermore, the NFT may be sold as a pack containing one or a plurality of random NFTs. In this case, when the NFT management unit 24 transfers the pack to the wallet of the buyer of the NFT, which will be described later, the NFT related to a product, which is randomly selected and purchased by the buyer, is transferred to the wallet of the buyer.

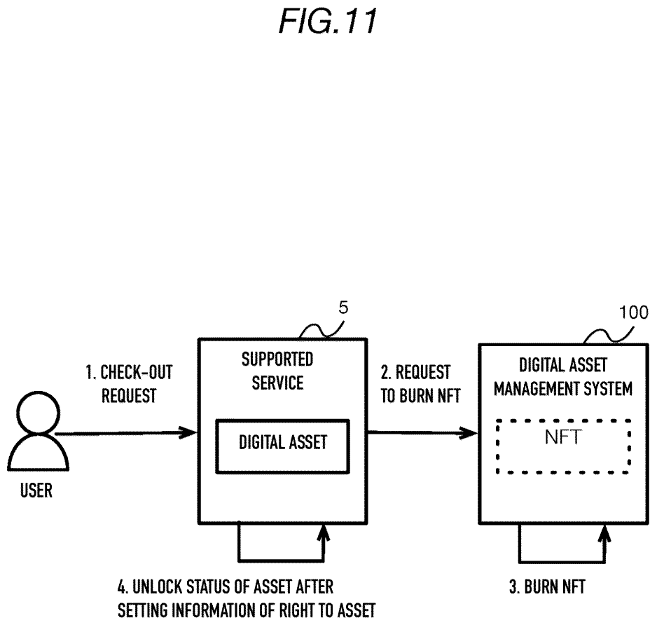

FIG. 11 is a diagram depicting an overview of the check-out processing according to the present embodiment. When the user requests check-out to the supported service 5, the supported service 5 requests the digital asset management system 100 to burn the NFT related to the target digital asset, and the digital asset management system 100, which received the request, burns the NFT related to the target digital asset, and notifies this information to the supported service 5. The supported service 5 unlocks the status of the corresponding digital asset at a timing of burning of the NFT, and provides the right to the digital asset to the user having the account corresponding to the holder of the burnt NFT. The flow of the check-out processing according to the present embodiment will now be described with reference to a flow chart.

FIG. 12 is a flow chart depicting a flow of the check-out processing according to the present embodiment. The processing in this flow chart is executed at a timing when the operation to start the check-out processing is performed on the user terminal 9 of the user, who desires to shift the management of the digital asset, of which management has been shifted from the supported service 5 to the digital asset management system 100, to the supported service 5.

In steps S401 to S406, a list of the digital assets for which check-out is possible is presented, and check-out is requested. The user terminal 9, which received the operation to start the check-out processing from the user, requests the server of the supported service 5 to send the data by which the NFTs held by this user can be confirmed (step S401), and the supported service 5, which received the request, sends a request to link the user ID, and a request to confirm the NFTs held by the user having the linked user ID, to the server of the digital asset management system 100 (step S402). Specifically, the supported service 5 calls an API for linking the user ID, and an API for confirming the NFTs held by the user having the linked user ID, which are provided by the digital asset management system 100.

The NFT management unit 24 of the digital asset management system 100, which received the request to link the user ID and the request to confirm the NFTs held by the user having the linked user ID, refers to the wallet held by this user using the linked user ID, and thereby acquires the list of the NFTs held by the specified user, and sends the list to the supported service 5 (step S403). Then the supported service 5 which received the list sends a check-out possible NFT list, which is a list of NFTs from which NFTs currently exhibited have been removed from the choices of the check-out target choice, to the user terminal 9 (step S404). However the currently exhibited NFTs may be removed at a timing when the digital asset management system 100 acquires the list, or may be removed at a timing when the supported service 5 sends the list to the user terminal 9, or may be removed at a timing when the user terminal 9 displays the list.

The user terminal 9 which received the list outputs a list of NFTs which the user of the user terminal 9 holds and which are not exhibited (check-out possible NFT list), such that the user can confirm this information (e.g. displays on a display) (step S405), receives operation to select a desired NFT from the user, and sends the request to check-out the selected NFT to the supported service 5 (step S406). Then processing advances to step S407.

In steps S407 to S411, the NFT of the check-out target digital asset is burnt, and unlock of the status of the digital asset related to the check-out request and right information setting are performed. The supported service 5 which received the check-out request sends a request to link the user ID and a request to delete the target NFT to the server of the digital asset management system 100 (step S407). Specifically, the supported service 5 calls an API for linking the user ID and an API for deleting the target NFT, which are provided by the digital asset management system 100. Here the delete target NFT may be specified by the token ID.

The NFT invalidating unit 26 of the digital asset management system 100, which received the request to link the user ID and the request to delete the target NFT, specifies the wallet and the NFT of this user with reference to the user ID and the token ID, and performs an operation to burn the target NFT for the blockchain 7 (step S408), to cause the blockchain 7 to burn the target NFT (step S409), and the target NFT is shifted to an unusable state. The completion of burning is notified to the service of the supported service 5.

As the target NFT is burnt, the unlock instructing unit 25 of the digital asset management system 100 sets the last holder of the digital asset related to the target NFT before burning the NFT as the user who has (holds) a right to this digital asset, in the server of the supported service 5, and unlocks the status of this digital asset (check-out target digital asset) (step S410). Thereby the use or disposal of the check-out target digital asset becomes possible for the latest user. Then the supported service 5 notifies the user terminal 9 of the user who is the right holder of the unlocked digital asset (that is, the user who performed the check-out operation) that the target digital asset is unlocked and can be used (step S411). Then the processing in this flow chart ends.

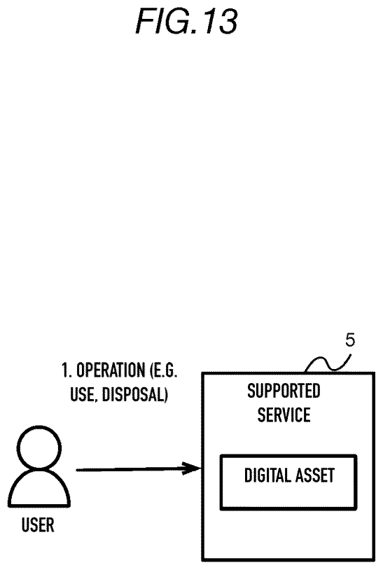

FIG. 13 is a diagram depicting an overview of the use of a digital asset according to the present embodiment. The user, who is provided a right to the target digital asset by check-out, can use or dispose this digital asset in the supported service 5. For example, if the digital asset is a game item, the user can use, transfer, sell or dispose this item during the game, and if the digital asset is a ticket, the user can participate in the event using this ticket, or transfer or sell the ticket within a rule of the supported service 5. If the digital asset is an electronic book, the user can read this electronic book, or transfer or sell the electronic book within a rule of the supported service 5.

In the present embodiment, the digital asset management system 100 may perform the check-in processing again for the check-out target digital asset, which was unlocked by burning the target NFT, in accordance with the above mentioned flow chart. The NFT of the digital asset issued by this secondly implemented check-in processing is different from the NFT of the digital asset (burnt NFT) before the previous check-in processing. In other words, the token ID (identifier of NFT) of the NFT issued by the N-th check-in processing (N>1, N is a natural number) for the same digital asset, is different from the token ID of the NFT issued by the (N−1)th check-in processing. This makes it unnecessary to manage all the NFTs corresponding to the enormous number of digital asset groups respectively, and an efficient blockchain network can be implemented in the digital asset management.

### Effect

According to the technique disclosed in the embodiments, in a predetermined service which manages digital assets without using non-fungible tokens, the convenience and safety in the management of the digital assets can be improved without constructing functions to use or dispose non-fungible token based digital assets in the predetermined service.

### First Variation

In the embodiment described above, one blockchain is used, but the technique according to this disclosure is also applicable to a case of using a plurality of blockchains. For example, an NFT generated by the check-in processing may be transferred to a public blockchain, and be traded on the public blockchain. The marketplace may support multi-chains for transfer of NFTs and/or FTs.

### Second Variation

In the embodiment described above, the NFT issued by check-in is provided to the wallet of the first user, then is exhibited in the marketplace in accordance with the operation by the first user, but the NFT issued by check-in may be temporarily provided to a wallet for generation (manager's wallet), then provided to the wallet of the first user at a timing of exhibition thereafter. Further, the NFT issued by check-in may be temporarily provided to the wallet for generation (manager's wallet), then provided to the wallet of the second user at a timing of transfer to the second user thereafter.

### Third Variation

In the embodiment described above, check-in is performed by operation of a user (seller), but the digital asset managed by the supported service may be converted in response to the purchase request from a user (buyer). For example, if the supported service is an electronic book service, the user who desires to purchase an electronic book selects the desired electronic book from a list of electronic books being sold by the supported service, and sends the purchase request to the supported service. When the purchase request is received, the supported service performs the check-in processing for the selected electronic book, so as to convert the management to the digital asset management system. The digital asset management system issues an NFT of the electronic book and transfers this NFT to the wallet of the user (buyer), whereby the purchase processing of the electronic book is completed. The user (buyer) requests the supported service and/or the digital asset management system to check-out the NFT provided to the wallet of this user, and when the check-out is completed, the supported service allows the user (buyer) to read this electronic book using an electronic book reader. Here the supported service may check the blockchain before allowing the reading, so as to confirm that the NFT has been burnt. The digital asset may be audio content or video content instead of the electronic book. The supported service may be a streaming service related to the digital asset, or may be a download service related to the digital asset.

### Fourth Variation

In the embodiment described above, a blockchain is used as an example of the distributed ledger, but the distributed ledger that can be used to implement the technique of the present disclosure is not limited to the blockchain. A distributed ledger other than the blockchain may be used as long as the distributed ledger includes the functions and configuration required to implement the technique of the present disclosure.

What is claimed is:

1. A digital asset management system comprising:
a memory; and
a processor coupled to the memory, the processor being configured to execute:
instructing a predetermined supported service to perform lock processing so as to limit use or disposal of a digital asset, which is provided by the supported service and to which a first user has a right;
issuing a non-fungible token, of which holder is the first user, for the digital asset locked by the supported service, on a distributed ledger such that the non-fungible token is corresponded with metadata which indicates data related to the digital asset;
instructing the supported service to perform unlock processing so as to cancel the limit of use or disposal of the digital asset locked by the supported service, and for instructing the supported service, at a timing of the unlock processing, to perform unlock after setting a user corresponding to a holder of the non-fungible token as a user having a right to the digital asset; and
in a case of performing the unlock processing, causing the non-fungible token related to the unlock processing to transit to an unusable state.

2. The digital asset management system according to claim 1, the processor further executes
changing the holder of the non-fungible token from the first user to a second user, wherein
the processor instructs implementation of the unlock processing to the supported service so as to perform unlocking after setting the second user, who has become a holder of the non-fungible token by the holder change, as a user having a right to the digital asset.

3. The digital asset management system according to claim 2, wherein
the processor makes the non-fungible token purchasable by other users, including the second user, by registering the non-fungible token in a marketplace in accordance with an operation of the holder of the non-fungible token, and in a case where a purchase operation for the non-fungible token registered in the marketplace is received from the second user and the purchase is approved, the processor changes the holder of the non-fungible token to the second user who has performed the purchase operation.

4. The digital asset management system according to claim 2 wherein the processor further executes
storing a correspondence between user identification information for identifying the user in the supported service, and user identification information for identifying the holder of the non-fungible token in the digital asset management system, and wherein
the processor instructs the supported service to perform unlock after setting the second user, who has been specified by referring to the correspondence, as a user having a right to the digital asset.

5. The digital asset management system according to claim 1, wherein
in a case of issuing the non-fungible token, the processor records in the distributed ledger not only data related to the digital asset acquired from the supported service, but also the metadata including data generated by the digital asset management system.

6. The digital asset management system according to claim 5, wherein
the processor inputs data on a digital asset to a learned model, of which input value is the data on the digital asset and output value is attribute data of the digital asset, and outputs estimated attribute data as output, so as to generate data to be included in the metadata, and record in the distributed ledger the metadata including the generated data.

7. The digital asset management system according to claim 1, wherein
in a case of issuing the non-fungible token, the processor records in the distributed ledger not only data related to the digital asset acquired from the supported service, but also the metadata including data acquired from a service, other than the supported service, by the digital asset management system.

8. The digital asset management system according to claim 1, wherein
in a case of performing the unlock processing, the processor burns the non-fungible token related to the unlock processing, so as to cause the non-fungible token to transit to an unusable state.

9. The digital asset management system according to claim 1, wherein
the digital asset provided by the supported service includes any of a game item or game data provided by a game service, an electronic ticket or a physical ticket reservation right provided by a ticket service, a reading right to an electronic book provided by an electronic book service, and a service access right provided by an arbitrary service.

10. A method performed by a computer of a digital asset management system comprising:
instructing a predetermined supported service to perform lock processing so as to limit use or disposal of a digital asset which is provided by the supported service and to which a first user has a right;
issuing a non-fungible token, of which holder is the first user, for the digital asset locked by the supported service, on a distributed ledger such that the non-fungible token is corresponded with metadata which indicates data related to the digital asset;
instructing the supported service to perform unlock processing so as to cancel the limit of use or disposal of the digital asset locked by the supported service, and of instructing the supported service, at a timing of the unlock processing, to perform unlock after setting a user corresponding to the holder of the non-fungible token as a user having a right to the digital asset; and
in a case of performing the unlock processing, causing the non-fungible token related to the unlock processing to transit to an unusable state.

11. A non-transitory computer-readable recording medium having recorded thereon a program configured to cause a computer of a digital asset management system to execute:
instructing a predetermined supported service to perform lock processing so as to limit use or disposal of a digital asset which is provided by the supported service and to which a first user has a right;
issuing a non-fungible token, of which holder is the first user, for the digital asset locked by the supported service, on a distributed ledger such that the non-fungible token is corresponded with metadata which indicates data related to the digital asset;
instructing the supported service to perform unlock processing so as to cancel the limit of use or disposal of the digital asset locked by the supported service, and of instructing the supported service, at a timing of the unlock processing, to perform unlock after setting a user corresponding to the holder of the non-fungible token as a user having a right to the digital asset; and
in a case of performing the unlock processing, causing the non-fungible token related to the unlock processing to transit to an unusable state.
